(19) United States
(12) Patent Application Publication
(10) Pub. No.: US 2025/0052605 A1
(43) Pub. Date: Feb. 13, 2025

(54) Soap Level Indication System

(71) Applicant: Bradley Company, LLC, Menomonee Falls, WI (US)

(72) Inventors: Axel Koentopp, Oberaudorf (DE); Josh Meyers, Menomonee Falls, WI (US)

(21) Appl. No.: 18/717,775

(22) PCT Filed: Dec. 8, 2022
(86) PCT No.: PCT/US2022/052278

§ 371 Date: Jun. 7, 2024

Related U.S. Application Data
(60) Provisional application No. 63/287,241, filed on Dec. 8, 2021.

(51) Int. Cl. G01F 23/66; A47K 5/13

(52) U.S. Cl. CPC G01F 23/66; A47K 5/13

(57) ABSTRACT

A soap dispenser having a soap level indication system includes a soap container with a main volume surrounded by one or more sidewalls, a channel disposed along at least one sidewall of the one or more sidewalls and being fluidically coupled to the main volume of the soap container via a passage, a float structure disposed within the channel and configured to float in a liquid within the soap container, and a level indicator disposed along an exterior surface of at least one sidewall of the one or more sidewalls. The level indicator is located adjacent the float structure. Further, the level indicator and the float structure are magnetically coupled to each other so that the level indicator indicates the location of the float structure within the channel.

### CROSS-REFERENCE TO RELATED APPLICATION

The present application claims priority to U.S. Provisional Patent Application No. 63/287,241, filed on Dec. 8, 2021. The entire contents of which are incorporated by reference herein.

### BACKGROUND OF THE INVENTION

### 1. Field of the Invention

The present invention relates in general to the field of lavatory accessories. More particularly, the present invention relates to a soap level indication system of a soap dispenser. Specifically, a preferred embodiment of the present invention relates to a soap level indication system having a float that moves with the level of fluid in the soap container.

### 2. Discussion of the Related Art

Soap dispensers commonly used with commercial lavatory systems generally include of a container for holding a volume or supply of soap, for example liquid soap or foam soap. The container holds the supply of liquid soap and is typically a refillable container. Liquid soap dispensers are commonly found in high traffic washrooms like those of shopping malls and centers, schools and universities, airports and bus/rail depots, concert and sport arenas, stadiums, movie theaters and playhouses, parks, and restaurants.

Maintenance personnel are typically charged with periodically inspecting the liquid soap supply to ensure that the level of liquid soap is sufficient to meet the expected short-term demand. This typically requires maintenance personnel to either remove the container or other element of the soap dispenser to view the inside of the level of soap in the container. Even in soap dispensers designed to see the soap container inside the dispenser, it can be hard to identify the soap level due to the color of the soap and potential distortion in the viewing window. Given these and other difficulties in determining the amount of liquid soap remaining in a given container, it is not uncommon for maintenance personnel to either ignore their responsibility altogether until notified by a visitor that liquid soap is unavailable at one or more of the wash basins or “top off” the liquid soap supply with each check of the fill level. While the latter is certainly preferred over the former from a customer service level, constantly topping off the soap container with replenishing soap adds to the man-hours required to service a washroom.

Thus, it would be desirable to provide a soap dispenser with a soap level indication system that easily indicates to maintenance personnel the level of soap within the container and/or whether the container needs to be refilled.

### SUMMARY AND OBJECTS OF THE INVENTION

The present invention is directed to a soap level indication system for a soap dispenser. In addition, the soap level indication system includes a float within the soap container and an associated indicator outside the soap container.

In accordance to an embodiment of the invention, a soap level indication system includes a soap container having a main volume surrounded by one or more sidewalls. A channel is disposed along at least one sidewall of the one or more sidewalls and is fluidically coupled to the main volume of the soap container via a passage. A float structure is disposed within the channel and configured to float in a liquid within the soap container. A level indicator is disposed along an exterior surface of at least one sidewall of the one or more sidewalls. The level indicator is located adjacent the float structure. Further, the level indicator and the float structure are magnetically coupled to each other so that the level indicator indicates the location of the float structure within the channel.

According to another aspect of the invention, the soap container includes a plurality of inner walls extending inward from at least one of the sidewalls of the soap container to form the channel having a channel volume. In turn, an inner volume of the soap container is divided into the main volume and the channel volume. The main volume and the channel volume are fluidically coupled together via a passage volume of the passage.

According to yet another aspect of the invention, the float structure includes a plurality of buoyant elements and a magnetic element extending through the plurality of buoyant elements. Additionally, the level indicator includes a magnetic element that interacts with the magnetic element of the float structure.

According to another aspect of the invention, the soap level indication system is placed within a soap dispenser housing that has an indicator opening formed in the housing. In turn, the level indicator is aligned with the indicator opening when the level indicator is disposed at a predetermined low level that indicates a need to refill of the soap container.

According to yet another aspect of the invention, the soap level indication system also includes a level indicator mount coupled to the exterior surface of at least one sidewall of the one or more sidewalls. The level indicator mount includes a vertically oriented channel. Meanwhile, the level indicator is slidably engaged with the channel of the level indicator mount. More preferably, the level indicator includes a level indicator plate and an extension extending from a rear surface of the level indicator plate, and the extension is slidably engaged with the channel of the level indicator mount.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is an isometric view of a soap dispenser having a soap level indicator system according to an embodiment of the invention;

FIG. 2 is a front elevation view of the soap dispenser of FIG. 1;

FIG. 3 is a side elevation view of the soap dispenser of FIG. 1;

FIG. 4 is an isometric view of the soap level indication system according to an embodiment of the invention;

FIG. 5 is a top view of the soap level indication system of FIG. 4 disposed within the soap dispenser of FIG. 1;

FIG. 6 is a side elevation view of the soap level indication system of FIG. 4; and

FIG. 7 is a cross-section view of the soap level indication system of FIG. 6 taken along line 7-7.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

Throughout this description, various terms denoting direction, such as left and right, front and rear, up and down, top and bottom, and the like may be used. The directions are not intended to be limiting but are used to describe relationships of elements with respect to each other in the accompanying drawings. Unless mutually exclusive, it is contemplated that the elements may be reversed, for example, by turning a component around or upside down without deviating from the scope of the present invention.

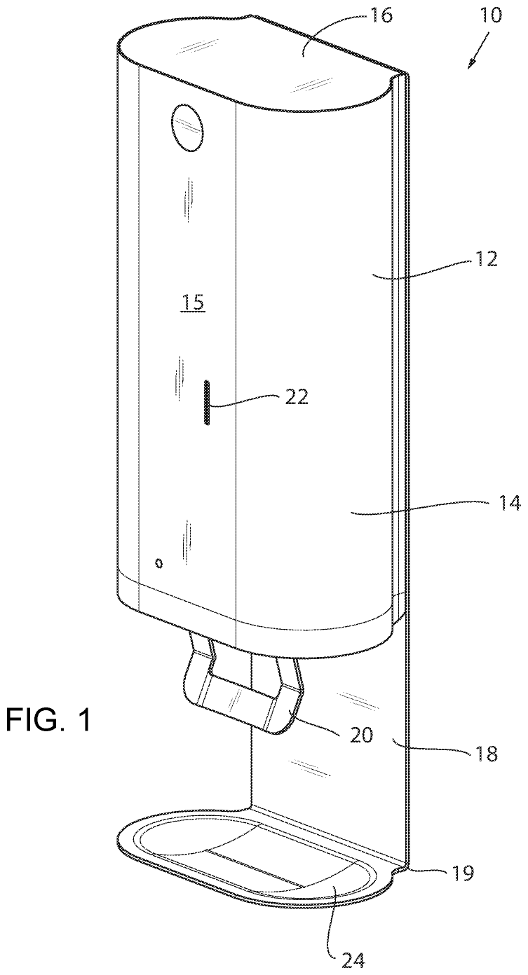

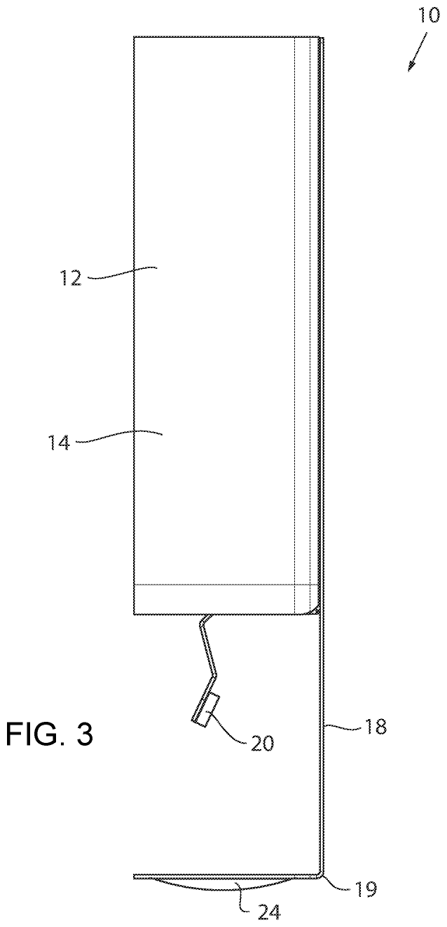

Turning initially to FIGS. 1-3, a soap dispenser 10 is shown according to one embodiment of the invention. The soap dispenser 10 includes a housing 12 having a shell 14, a top plate 16, and a back plate 18 surrounding an inner volume 13. In the representative embodiment of the invention, the shell 14 of the housing 12 is shown as a rounded structure. Meanwhile, in varying embodiments of the invention, the shell 14 can include any number of sidewalls formed into any shape. In addition, the shell 14 may include or be a door that opens to expose the inner volume 13 of the soap dispenser 10.

In the representative embodiment of the invention, the back plate 18 extends beyond the shell 14 and terminates at a distal end 19 spaced apart from the shell 14. Additionally, a bottom plate 24 may extend outward from the distal end 19 of the back plate 18. The bottom plate 24 may be concave in design and configured to catch fluid dispensed by the dispenser 10. The distance between the bottom plate 24 and the bottom of the shell 14 is sized to allow a user to place their hand between the bottom of the shell 14 of the housing 12 and the bottom plate 24 in order to receive a fluid, such as soap, from the dispenser 10.

Further, the dispenser 10 includes an activation element 20 disposed at the bottom of the shell 14. The activation element 20 may be triggered by the user to have the dispenser 10 discharge an amount of fluid. While the representative embodiment of the invention shows the activation element 20 as a manually activated element, it is contemplated that other embodiments of the invention may use an activation element activated via a sensor or other style manual element.

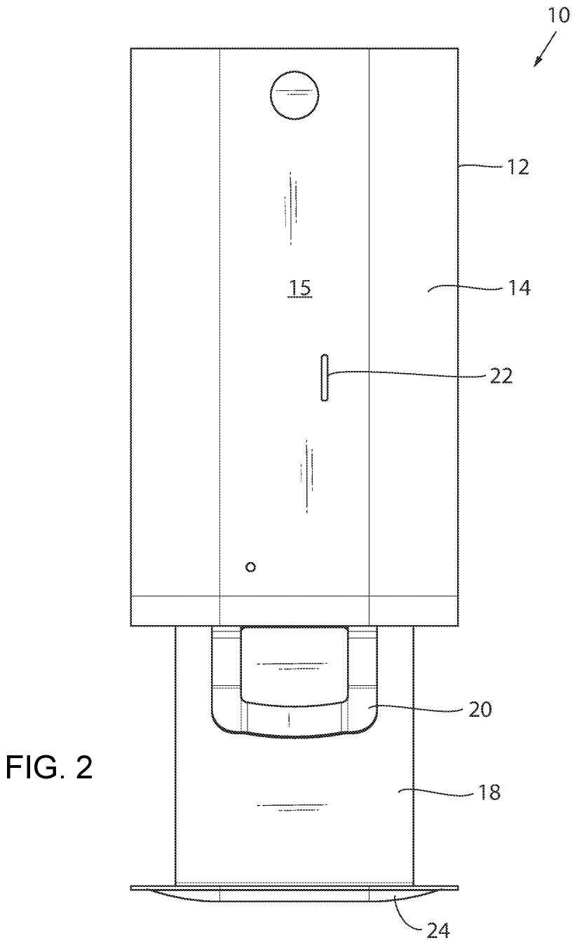

As shown in FIGS. 1 and 2, a front surface 15 of the shell 14 of the housing 12 includes an indication opening 22. The indication opening 22 may be an opening in the shell 14. The indication opening 22 may be either completely open to the inner volume 13 of the dispenser 10 or include a clear barrier that is visually open to the inner volume 13 of the dispenser 10. In turn, the indication opening 22 is located to allow a use to identify when a soap container 26 disposed within the dispenser 10 needs to be refilled.

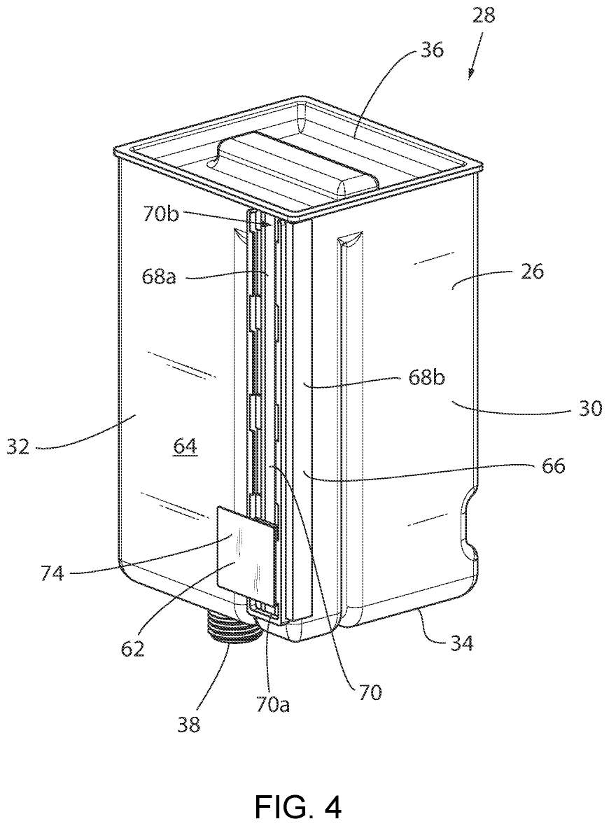

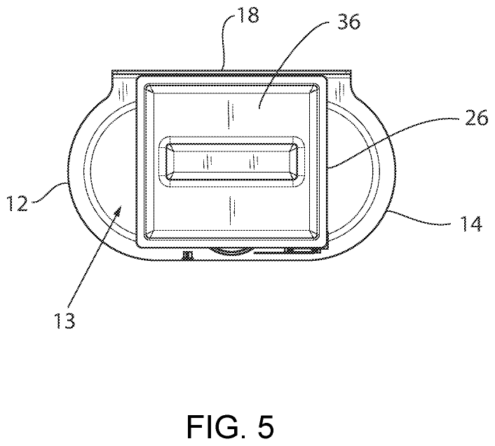

Now referring to FIG. 4, the soap container 26 of a soap level indication system 28 is shown in accordance with an embodiment of the invention. The soap container 26 includes a housing 30 having a plurality of sidewalls 32, a bottom surface 34, and a lid 36. While the representative embodiment of the invention shows the housing 30 and its plurality of sidewalls 32 in the shape of a square, varying embodiments of the invention may include the housing 30 with any number of sidewalls 32 in any shape, including, but not limited to, a circle, a rectangle, a triangle, a pentagon, etc. The bottom surface 34 further includes an outlet 38 disposed therein to fluidically couple the soap container to a pump (not shown). Additionally, the lid 36 is removably disposed at the top housing 30 and is able to be removed for adding or removing liquid from the soap container 26. FIG. 5 further illustrates the soap container 26 disposed within the inner volume 13 of the soap dispenser 10. For the purposes of illustration, the top plate 16 has been removed from the soap dispenser 10.

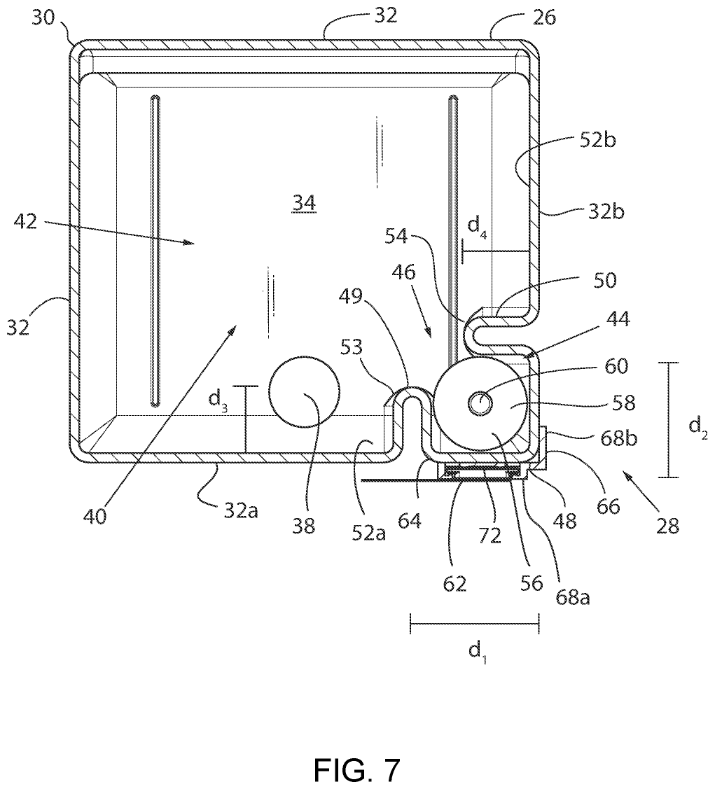

The cross-sectional view of FIG. 7 illustrates an inner volume 40 of the soap container 26. The inner volume 40 of the soap container 26 may be distinguished into a main volume 42 and a channel volume 44 that are fluidically coupled to each other via a volume passage 46. In the representative embodiment of the invention, adjacent sidewalls 32a, 32b meet in a corner 48 of the housing 30 of the soap container 26. Each sidewall 32a, 32b, includes a respective inner wall 49, 50 extending inwards from an inner surface 52a, 52b of the sidewall 32a, 32b.

Inner wall 49 extends inward from the inner surface 52a of the sidewall 32a at a distance d₁ from the corner 48, while inner wall 50 extends inward from the inner surface 52b of the sidewall 32b at a distance d₂ from the corner 48. In varying embodiments of the invention, d₁ may be equal to, greater than, or less than d₂. The extension of inner walls 49, 50 into the volume 40 of the soap container 26 divides the volume 40 into the channel volume 44 adjacent the corner 48 and the main volume 42. As shown in FIG. 7, the outlet 38 of the soap container 26 is preferably aligned with the main volume 42 of the soap container 26.

Inner wall 49 extends inward from the inner surface 52a of the sidewall 32a for a distance d₃, while inner wall 50 extends inward from the inner surface 52b of the sidewall 32b for a distance d₄. In the representative embodiment of the invention, da is less than d₁ and d₃ is less than d₂. As a result, a distal end 53 of the inner wall 49 and a distal end 54 of the inner wall 50 are spaced apart from each other to form the volume passage 46 that fluidically couples the main volume 42 and the channel volume 44—may also be referred to as main volume 42 and secondary volume 44—to allow the fluid within the volume 34 of the soap container 26 to freely flow between and maintain a consistent fluid level between the two volumes 42, 44.

In varying embodiments of the invention, the inner walls 49, 50 may extend from the same or different sidewalls 32 of the housing 30 in any manner to form a volume passage 46 to fluidically couple and partially separate or restrict the channel volume 44 from the main volume 42. As a result, while the channel volume 44—may also be referred to as channel 44—is shown as being disposed adjacent the corner 48 of the housing 30 of the soap container 26, it is contemplated that the channel 44 may be disposed at any location along an inner surface 52 of one or more sidewalls 32 of the housing 30.

As shown in FIG. 7, a float structure 56 is positioned within the channel 44 of the soap container 26. The float structure 56 is sized so that it is smaller in size than the width of the channel 44 so that it can move freely within the channel as the fluid level lowers within the soap container 26 due to use of the soap dispenser 10 and rises within the soap container 26 due to refilling. In the preferred embodiment of the invention, the float structure 56 is formed of buoyant elements 58 stacked on top of each other, for instance, three foam balls. In other embodiments of the invention, the float structure 56 may include any number of buoyant elements 58 preferably oriented in the vertical direction. Further, the float structure 56 includes a magnetic element 60 extending vertically through the buoyant elements 58.

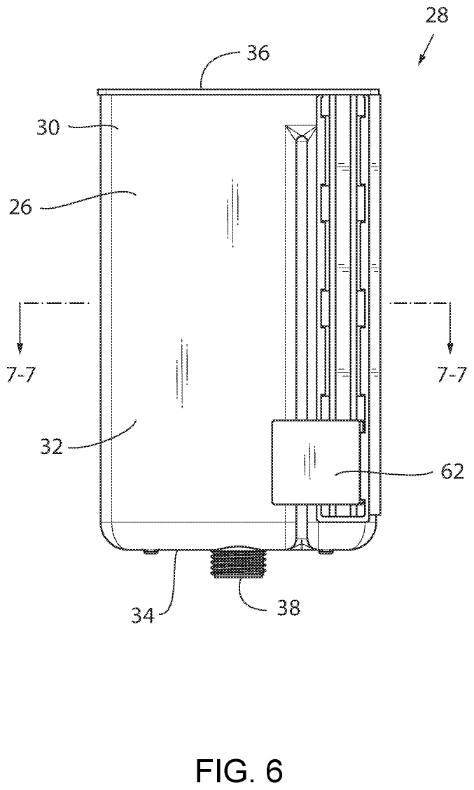

Referring again to FIGS. 4 and 6, the soap level indication system 28 further includes a level indicator 62 adjacent an exterior surface 64 of the housing 30 and aligned with a magnetic element 60 of the float structure 56. In the representative embodiment of the invention, the soap level indication system 28 includes a level indicator mount 66 coupled to the exterior surface 64 of the housing 30 and disposed between the level indicator 62 and the housing 30.

The level indicator mount 66 may be coupled to the exterior surface 64 of the housing 30 by any means. As shown in FIGS. 4 and 6, the level indicator mount 66 may extend around more than one sidewall 32. For instance, the level indicator mount 66 may include a first wall 68a aligned with respective sidewall 32a, while a second wall 68b is aligned with respective sidewall 32b. In varying embodiments of the invention, the level indicator mount 66 may be sized to extend around any number of sidewalls 32.

In the representative embodiment of the invention, the level indicator mount 66 includes a channel or pathway 70 formed therein and configured to receive the level indicator 62. The pathway 70 may extend vertically or substantially vertically from a first end 70a to a second end 70b. In varying embodiments of the invention, the first and second ends 70a, 70b of the pathway 70 may be located at, adjacent, or displaced from the upper and lower ends of the indicator mount 66. The indicator 62 includes an indicator plate 74 and an extension 72 on a rear surface of the indicator plate 74 sized to fit within the pathway 70 of the indicator mount 66 to allow vertical movement of the indicator 62. Preferably, the extension 72 may be or include a magnetic element configured to interact with the magnetic element 60 of the float structure 56. As a result, the pathway 70 of the indicator mount 66 allows the indicator 62 to move up and down as the float structure 56 moves with the changing level of the fluid in the soap container 26. Alternatively, the magnetic element of the indicator 62 may be included in the indicator plate 74 or any other location.

Referring again to FIG. 1, the indicator opening 22 is located so as to be adjacent to or align itself with the lower end 70a of the channel. As a result, when the fluid level in the soap container 26 is low, the float structure 56 and magnetically coupled indicator 62 approach the lower end 70a of the pathway 70, and the indicator plate 74 is aligned with the indicator opening 22 in order to notify a user that the soap container 26 needs to be refilled. Conversely, when the soap container 26 contains enough soap, the fluid level is high and the float structure 56 and magnetically coupled indicator 62 are spaced apart from the lower end 70a of the pathway 70, and the indicator plate 74 is located higher and is not visible through the indicator opening 22.

The indicator plate 74 may be colored, textured, or otherwise differentiated to be easily identifiable when aligned with the indicator opening 22. In varying embodiments of the invention, the indicator opening 22 may be located or sized to provide indication of a need to refill at different predetermined fluid levels of the soap container 26.

Although the best mode contemplated by the inventors of carrying out the present invention is disclosed above, practice of the present invention is not limited thereto. It will be manifest that the various additions, modifications, and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A soap level indication system comprising:
a soap container having a main volume surrounded by one or more sidewalls;
a channel disposed along at least one sidewall of the one or more sidewalls, the channel fluidically coupled to the main volume of the soap container via a passage;
a float structure disposed within the channel, the float structure configured to float in a liquid within the soap container; and
a level indicator disposed along an exterior surface of at least one sidewall of the one or more sidewalls, the level indicator disposed adjacent the float structure, the level indicator and the float structure being magnetically coupled to each other so that the level indicator indicates the location of the float structure within the channel.

2. The soap level indication system of claim 1, further comprising:
a plurality of buoyant elements included in the float structure; and
a magnetic element extending through the plurality of buoyant elements.

3. The soap level indication system of claim 1, further comprising:
a soap dispenser housing having the indication system therein; and
an indicator opening formed in the housing;
wherein the level indicator is aligned with the indicator opening when the level indicator is disposed at a predetermined low level.

4. The soap level indication system of claim 1, further comprising a level indicator mount coupled to an exterior surface of at least one sidewall of the one or more sidewalls, the level indicator mount including a pathway vertically formed in the level indicator mount, and wherein the level indicator is slidably engaged with the pathway of the level indicator mount.

5. The soap level indication system of claim 4, further comprising a level indicator plate within the indicator mount and an extension extending from a rear surface of the level indicator plate, and wherein the extension is slidably engaged with the pathway of the level indicator mount.

6. The soap level indication system of claim 1, wherein the liquid is a soap.

7. The soap level indication system of claim 1, wherein the float structure is removable from the soap container.

8. A soap level indication system comprising:
a soap container including:
an inner volume surrounded by one or more sidewalls; and
a plurality of inner walls extending inward from at least one of the sidewalls to divide the inner volume into a main volume and a channel volume;
a float structure disposed within the channel volume, the float structure configured to float in a liquid within the soap container; and
a level indicator disposed along an exterior surface of at least one sidewall of the soap container, the level indicator disposed adjacent the float structure and magnetically coupled thereto so that the level indicator indicates the location of the float structure within the channel.

9. The soap level indication system of claim 8, wherein the float structure includes one or more buoyant elements and a magnetic element extending through the one or more buoyant elements.

10. The soap level indication system of claim 8, wherein the level indicator is aligned with a indicator opening of a soap dispenser when the level indicator is disposed at a predetermined low level.

11. The soap level indication system of claim 8, further comprising
a level indicator mount disposed at an exterior surface of at least one sidewall of the soap container; and
a pathway vertically formed in the level indicator mount;
wherein the level indicator is slidably engaged with the pathway of the level indicator mount.

12. The soap level indication system of claim 11, further comprising:
a level indicator plate; and
an extension extending from a rear surface of the level indicator plate, wherein the extension is slidably engaged with the pathway of the level indicator mount.

13. The soap level indication system of claim 8, wherein the main volume and the channel volume are fluidically coupled to each other via a volume passage.

14. The soap level indication system of claim 8, wherein the float structure is removable from the soap container.

15. The soap level indication system of claim 8, further comprising:
a channel disposed in a corner of the soap container; and
wherein the plurality of inner walls extend inward from two joined sidewalls.

16. A soap dispenser comprising:
a housing having an indicator opening formed in a surface of the housing;
a soap level indication system including:
a soap container disposed within the housing, the soap container having a main volume surrounded by one or more sidewalls;
a channel disposed along at least one sidewall of the one or more sidewalls, the channel fluidically coupled to the main volume of the soap container via a passage;
a float structure disposed within the channel, the float structure configured to float in a liquid within the soap container; and
a level indicator disposed along an exterior surface of at least one sidewall of the one or more sidewalls, the level indicator disposed adjacent the float structure, the level indicator and the float structure being magnetically coupled to each other so that the level indicator indicates the location of the float structure within the channel, and wherein the level indicator is aligned with the indicator opening of the housing when the level indicator is disposed at a predetermined low level.

17. The soap dispenser of claim 16, further comprising:
one or more buoyant elements on the float structure; and
a magnetic element extending through the plurality of buoyant elements.

18. The soap dispenser of claim 16, further comprising a level indicator mount coupled to an exterior surface of at least one sidewall of the one or more sidewalls, the level indicator mount including a pathway vertically formed in the level indicator mount, and wherein the level indicator is slidably engaged with the pathway of the level indicator mount.

19. The soap dispenser of claim 18, further comprising a level indicator plate within the indicator mount and an extension extending from a rear surface of the level indicator plate, and wherein the extension slidably engaged with the pathway of the level indicator mount.

20. The soap dispenser of claim 18, wherein the level indicator is aligned with the indicator opening of the housing when disposed at or adjacent a lower end of the pathway.
